(19) United States
(12) Patent Application Publication
(10) Pub. No.: US 2012/0167512 A1
(43) Pub. Date: Jul. 5, 2012

(54) CROSS STRUCTURE FOR WINDOWS AND DOORS OF TRADITIONAL KOREAN HOUSE

(75) Inventors: Eunyoung AHN, Daejeon (KR); Jaewon KIM, Chungcheongnam-do (KR)

(73) Assignee: HANBAT NATIONAL UNIVERSITY INDUSTRY-ACADAMIC COOPERATION FOUNDATION, Daejeon (KR)

(21) Appl. No.: 13/071,733

(22) Filed: Mar. 25, 2011

(30) Foreign Application Priority Data
Dec. 31, 2010 (KR) 10-2010-0139925

(51) Int. Cl. E06B 3/72; E06B 3/04

(52) U.S. Cl. 52/456

(57) ABSTRACT

Disclosed herein is a door for traditional Korean houses. The door includes a structure of a lattice door framed with vertical lattice frames and horizontal lattice frames which are arranged in a regular periodic pattern. A lattice width-to-height ratio (W/H) of the lattice door ranges from 0.07 to 0.1 so that the outside air is prevented from entering the interior of a room through the lattice door to minimize heat loss from the interior of the room to the outside air. Therefore, the present invention can satisfy the basic function of insulating the interior of the room born the outside air. Thereby, energy consumption can be reduced.

This application claims the benefit of Korean Patent Application No. 10-2010-0139925, filed Dec. 31, 2010, which is hereby incorporated by reference in its entirety into this application.

### BACKGROUND OF THE INVENTION

1. Technical Field

The present invention relates generally to windows and doors for traditional Korean houses (Hanok) and, more particularly, to windows and doors for traditional Korean houses which have a lattice structure that can minimize heat loss in the winter.

2. Description of the Related Art

Windows and doors are installed in openings, such as entrances, etc., so as to isolate the interior region of a building from the outside. Windows and doors are classified into Oriental style and Western style. Windows and doors of traditional Korean houses, which are made of wood frames and window paper, are representative examples of the Oriental style windows and doors.

Windows and doors of traditional Korean houses have a variety of shapes; for example, a lattice door shape which is framed with vertical lattice frames and horizontal lattice frames which are arranged in a regular periodic pattern to form the same lattice cells, a partial lattice shape which is partially framed with lattice frames, an octagonal double window shape in which a separate window is formed in a central portion of a door and window paper is applied only to the separate window and wallpaper is applied to the other portion of the door to interrupt transmission of light.

Such windows and doors of traditional Korean houses make a room bright and provide graceful and elegant beauty matching even modern tastes. However, because windows and doors of traditional Korean houses are made of wood frames and thin window paper, there is a disadvantage in that the basic function of insulating room temperature.

### SUMMARY OF THE INVENTION

Accordingly, the present invention has been made keeping in mind the above problems occurring in the prior art, and an objective of the present invention is to provide windows and doors for traditional Korean houses which have a lattice structure which can minimize heat loss attributable to convection heat transfer, so that the basic function of insulating the inside, air from the outside air can be satisfied.

In order to accomplish the above objective, the present invention provides a door for traditional Korean houses, including a structure of a lattice door framed with vertical lattice frames and horizontal lattice frames which are arranged in a regular periodic pattern, wherein a vertical velocity (V) of a natural convection flows in each of lattice cells with respect to a gravity direction is obtained from an equation

$$V = {( R a P r )}^{1 / 2} \frac{k}{H} ,$$

a velocity (U) by the mass conservation in the lattice cell with respect to the horizontal direction is obtained from an equation

$$U = {( R a P r )}^{7 / 16} {A}^{- 1 / 2} \frac{k}{H} ,$$

and a minimum value of a lattice width to height ratio, aspect ratio, (W/H) of the lattice door is obtained by V≅U, (where W denotes a horizontal length of the lattice cell, H denotes a vertical length of the lattice cell, Ra denotes the Rayleigh number, Pr denotes the Prandtl number, A denotes a lattice width-to-height ratio (W/H) and k denotes a thermal diffusion coefficient).

The equation of the velocity (V) and the equation of the velocity (U) may be obtained by a well-known relation, Brunt-Vaisala frequency,

$$N = {( \frac{α g Δ T}{H} )}^{1 / 2} ,$$

(where α denotes a coefficient of thermal expansion, g denotes the acceleration of gravity, ΔT denotes a temperature difference between an inside air and an outside air, and H denotes the vertical length of the lattice cell).

The main idea lies on the formation of circulating flows inside lattice cells to protect the heat transfer between indoor region and exterior one at lower temperature.

The lattice width-to-height ratio (W/H) of the lattice door may range from 0.07 to 0.1.

The vertical lattice frames and the horizontal lattice frames may protrude toward the outside of the door, and window paper may be attached to an indoor side of the vertical and horizontal lattice frames.

In order to accomplish the above objective, the present invention provides a door for traditional Korean houses, including a structure of a lattice door framed with vertical lattice frames and horizontal lattice frames which are arranged in a regular periodic pattern, wherein a lattice width-to-height ratio (W/H) of the lattice door ranges from 0.07 to 0.1 such that an outside thermal flux is prevented from entering an interior of a room through the lattice door to minimize heat loss from the interior to the outside air, (where W denotes a horizontal length of each of lattice cells, H denotes a vertical length of the lattice cell).

### BRIEF DESCRIPTION OF THE DRAWINGS

The above and other objectives, features and advantages of the present invention will be more clearly understood from the following detailed description taken in conjunction with the accompanying drawings, in which:

FIG. 1 is a view illustrating a lattice width-to-height ratio (W/H) of a lattice door, according to an embodiment of the present invention; and

FIG. 2 is a view showing a vortex generated in each of the lattice cells according to the embodiment of the present invention.

### DESCRIPTION OF THE PREFERRED EMBODIMENTS

If in the specification, detailed descriptions of well-known functions or configurations may unnecessarily make the gist of the present invention, the detailed descriptions will be omitted.

The terms and words used in the present specification and the accompanying claims should not be limitedly interpreted as having their common meanings or those found in dictionaries, but should be interpreted as having meanings adapted to the technical spirit of the present invention on the basis of the principle that an inventor can appropriately define the concepts of terms in order to best describe his or her invention.

It should be noted that the same reference numerals are used throughout the different drawings to designate the same or similar components as much as possible.

Hereinafter, an embodiment of the present invention will be described in detail with reference to the attached drawings.

The present invention can be applied to a window or a door. In the following description, for the sake of description, the present invention will be illustrated as being applied to a door.

A door for traditional Korean houses according to the embodiment of the present invention has a lattice door structure. A lattice width-to-height ratio (W/H) of the lattice door is designed in such a way that vortexes, circulating flows, are generated by natural convection flows so that air layers are formed in respective lattice cells.

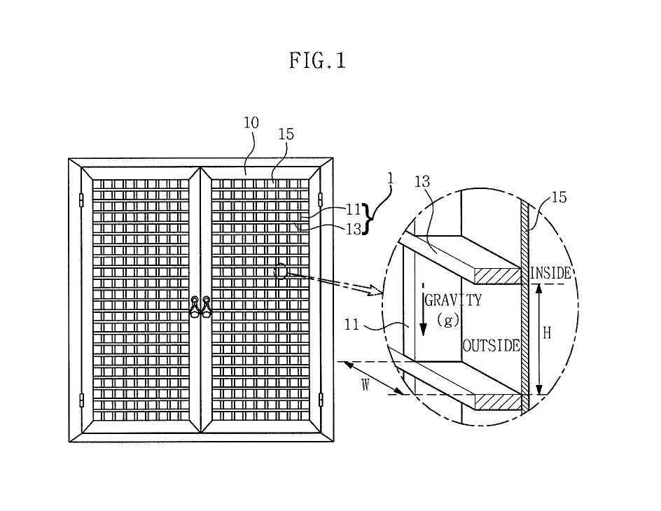

As shown in FIG. 1, the lattice door 10 is framed with vertical lattice frames 11 and horizontal lattice frames 13 which are arranged in a regular periodic pattern. The vertical lattice frames 11 and the horizontal lattice frames 13 protrude toward the outside, and window paper 15 is attached to the indoor sides of the vertical and horizontal lattice frames 11 and 13. The term “lattice cells” refers to rectangular spaces defined by the vertical lattice frames 11 and the horizontal lattice frames 13.

The lattice door structure provides a heat resistance effect induced by air layers formed in such a way that convection flows of the air are confined in the lattice cells. Besides the regular pattern of the lattice structure of the lattice door 10 makes it more attractive, thus enhancing the aesthetic value of the door. In addition, because the window paper 15 is made of semitransparent permeable material, the indoor space can be lightened.

The air layers formed by vortexes function as the best natural insulating material which can prevent the inside air from escaping and prevent the outside air from entering the interior of the room, thus minimizing heat loss of the inside air.

To achieve these purposes, the lattice width-to-height ratio (W/H) of the lattice door 10 is 0.01 or more and, preferably, ranges from 0.07 to 0.1. The value 0.01 is the minimum value of the lattice width-to-height ratio at which a vortex can be formed by a natural convection flows. When the lattice width-to-height ratio of the lattice door ranges from 0.07 to 0.1, vortexes are formed with satisfaction of conditions that heat loss of the inside air through the lattice door is 10% or less.

Such lattice width-to-height ratios of the lattice door 10 were derived to provide the structure of the door for traditional Korean houses that can minimize heat loss of the interior air through the lattice door 10.

Here, a ratio of an area of a region defining the lattice frames relative to the entire area of the lattice door was not taken into account because the lightening effect should have priority over other things in doors for traditional Korean houses. The thickness of the lattice door was also not taken into account because the lattice door of the present invention complies with the standard in the structure of traditional Korean houses.

Deriving the lattice width-to-height ratio of the lattice door includes deriving an equation related both to the velocity (V) of a natural convection flows in each lattice cell with respect to the gravity direction and to the velocity (U) of the natural convection flows in the lattice cell with respect to the horizontal direction, and deriving, from the equation, the minimum value of the lattice width-to-height ratio at which a vortex can be formed in the lattice cell by a natural convection flows. The term “natural convection flows” refers to a convection motion which is naturally generated by variation in density of air temperature difference.

The minimum value means the minimum value of a geometric variable of the lattice width-to-height ratio at which a vortex can be formed in the lattice cell by a natural convection movements.

Deriving the optimum lattice width-to-height ratio of the lattice door includes setting the geometric variable on the basis of the derived minimum value, producing samples depending on the geometric variable, and then carrying out heat quantity measurement depending on a temperature variable.

If the temperature of the outside air is lower than that of the inside air, heat transfer is induced by a difference there. For the sake of description, when it is assumed, for example, in the winter, that the temperature of the inside air is 20° C. and the temperature of the outside air is 5° C., deriving the theoretical optimum lattice width-to-height ratio that can maximize the heat insulation effect will be described below.

In the daytime, due to the characteristics of the lattice door, radiant heat of the sun is generally applied to the interior of the room through the lattice door. Therefore, in this description, only nighttime conditions will be considered. At night, the temperature of the outside air is generally lower than that of the surface of the earth, thus outside air around the door moves upward. The present invention confines such upward flows of air in the lattice cells, thus forming air layers exhibiting the heat resistance effect.

The equation related to the upward velocity (V) of a natural convection in the lattice cell with respect to the gravity direction and to lateral velocity (U) of the satisfaction of mass conservation in the lattice cell with respect to the horizontal direction can be derived by the following equation:

$$N = {( \frac{α g Δ T}{H} )}^{1 / 2} \qquad ( Equation 1 )$$

In Equation 1, α denotes a coefficient of thermal expansion, g denotes the acceleration of gravity in the downward direction, ΔT denotes a temperature difference between the inside is air and the outside air, H denotes a vertical length of the lattice cell, and N denotes the Brunt-Vaisala frequency, having a unit of 1/second.

The natural convection motion attributable to a temperature difference induce movement of an air flow. Brunt and Vaisala defined a pulsation phenomenon of the movement of the air flow and derived the N equation from the defining of the pulsation phenomenon.

N indicates the frequency of air flow resulting from a difference in density. Characteristic magnitudes of the upward velocity (V) of a natural convection flows in the lattice cell with respect to the gravity direction and the lateral velocity (U) of the satisfaction of mass conservation in the lattice cell with respect to the horizontal direction are determined by the N equation.

Therefore, the following Equations 2 and 3 can be obtained by combining the Brunt-Vaisala frequency and the difference of velocities order.

The vertical velocity (V) of the natural convection with respect to the gravity direction is obtained by the following Equation 2:

$$V = {( R a P r )}^{1 / 2} \frac{k}{H} \qquad ( Equation 2 )$$

The velocity (U) by mass conservation with respect to the horizontal direction is obtained by the following Equation 3:

$$U = {( R a P r )}^{7 / 16} {A}^{- 1 / 2} \frac{k}{H} \qquad ( Equation 3 )$$

In Equations 2 and 3, H denotes a vertical length of the lattice cell, Ra denotes the Rayleigh number, Pr denotes the Prandtl number, A denotes a lattice width-to-height ratio (W/H) and k denotes a thermal diffusion coefficient. For reference, the Rayleigh number Ra also contains a lattice width-to-height ratio A.

The Rayleigh number is a non-dimensional number defined by J. Rayleigh to determine whether a thermal convection flows occurs in a fluid layer. The Prandtl number is also a non-dimensional number.

From the above equations, a geometrical effective region within which a vortex flow can be induced is V≅U. In the embodiment, a circulating motion is an air flow which rotates in the lattice cell in a counterclockwise direction. Such a vortex flow form air layers in the lattice cell, thus insulating the inside air from the outside air.

If V≅U is not satisfied, a vortex flow may not be formed in each lattice cell, or a plurality of vortexes may be formed in each lattice cell, resulting in promoting heat transfer between the inside air and the outside air. Furthermore, a vortex which rotates in a counterclockwise direction, desired in this embodiment, may not be formed in each lattice cell. In this case, the effect of insulating the inside air from the outside air cannot be obtained.

Meanwhile, A≅10⁻² is derived from V≅U. The derived value 0.01 is the minimum value of a geometrical variable at which a vortex can be formed by a natural convection.

On the basis of the derived minimum value 0.01, the geometrical variable is set as a range from 0.01 to 0.12 by a computation predictions.

The theoretical basis used to determine the range of the geometrical variable was the Brunt-Vaisala frequency, and determining a detailed variable includes optimizing the geometrical variable using a response surface method.

As the result of the computation analysis, when the lattice width-to-height ratio is within the geometrical variable range, the vortex motion was formed, as shown in FIG. 2. The vortex flows of FIG. 2 acts in a mechanism which can restrict low temperature outside air from absorbing heat from the inside air, or in other words, prevent heat transfer between the outside an and the inside air.

For reference, the shape of the lattice shown in FIGS. 1 and 2 is only one example proposed to illustrate the process of deriving the lattice width-to-height ratio, and it will be easily understood that the present invention is not limited to this.

The following Table 1 shows the average of the temperature of the inside air according to a passage of time when it is assumed that the temperature of the outside air is 5° C. and the temperature attic inside air is 20° C.

Furthermore, in Table 1, lattice width-to-height ratios of samples were set by embodiments of the derived geometrical variables, and the temperature average of the inside air was obtained by heat quantity measurement using temperature variables.

TABLE 1

| | width-to-height ratio (W/H) | | | | | |
|---|---|---|---|---|---|---|
| elapsed time | 0.01 | 0.03 | 0.05 | 0.07 | 0.1 | 0.12 |
| 5 minutes | 18.7 | 18.7 | 18.8 | 19 | 18.9 | 18.7 |
| 20 minutes | 17.2 | 17.5 | 17.9 | 18.5 | 18.3 | 18.0 |
| 60 minutes | 17.2 | 17.3 | 17.8 | 18.5 | 18.2 | 17.8 |
| 150 minutes | 17.0 | 17.1 | 17.7 | 18.5 | 18.1 | 17.3 |
| Vortex flow | ◯ | ◯ | ◯ | ◯ | ◯ | ◯ |

From Table 1, the vortex flow shown in FIG. 2 was formed when the lattice width-to-height ratio ranges from 0.01 to 0.12, and the heat insulation effect was comparatively superior. In particularly, in the case where the lattice width-to-height ratio ranges from 0.07 to 0.1, there was little heat loss after 5 minutes have passed. Even when 150 minutes have passed, it was satisfied that a heat loss is less than 10%.

This was achieved by the fact that air which is supplied into the lattice cells of the lattice door by natural convection forms vortex flows which rotate in counterclockwise directions, thus forming air layers providing heat insulating effect so that heat loss from the inside air to the outside air can be minimized.

Accordingly, the lattice door structure is used in the present invention, and the lattice door is designed so that the lattice width-to-height ratio ranges from 0.07 to 0.1 so as to minimize heat loss from the inside to the outside.

As described above, the present invention provides a door for traditional Korean houses which has a lattice door structure with a lattice width-to-height ratio (W/H) which is designed by a geometrical optimizing process so that vortex flows are formed by natural convection so that air layers are formed in lattice cells.

The air layers having a thermal resistance are formed in the lattice cells function to prevent heat transfer between the inside air and the outside air, thus minimizing heat loss. Therefore, the present invention can satisfy the basic function of insulating the inside air from the outside air. Thereby, energy consumption can be reduced.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. Cross structure for windows and doors, comprising a structure of a lattice door framed with vertical lattice frames and horizontal lattice frames which are arranged in a regular periodic pattern,
wherein the lattice width-to-height ratio (W/H) of the lattice door ranges from 0.07 to 0.1.

2. (canceled)

3. (canceled)

4. (canceled)

5. The cross structure of claim 1, wherein the vertical lattice frames and the horizontal lattice frames protrude toward the outside of the door, and a window paper is attached to an indoor side of the vertical and horizontal lattice frames.

6. Cross structure for windows and doors, comprising a structure of a lattice door framed with vertical lattice frames and horizontal lattice frames which are arranged in a regular periodic pattern,
Wherein a lattice width-to-height ratio (W/H) of the lattice door ranges from 0.07 to 0.1 such that an outside air is prevented from entering an interior of a room through the lattice door to minimize heat loss from the interior to the outside air,
wherein W denotes a horizontal length of each of lattice cells, H denotes a vertical length of the lattice cell.
